(19) United States
(12) Patent Application Publication
(10) Pub. No.: US 2015/0247015 A1
(43) Pub. Date: Sep. 3, 2015

(54) THERMOSETTING RESIN COMPOSITION AND ITS USAGE

(71) Applicant: Shengyi Technology Co., Ltd., Guangdong (CN)

(72) Inventor: Yong CHEN, Guangdong (CN)

(21) Appl. No.: 14/617,071

(22) Filed: Feb. 9, 2015

(30) Foreign Application Priority Data
Mar. 3, 2014 (CN) 201410074898.7

(51) Int. Cl. C08J 5/24; C08L 63/00; C08L 63/04; C08L 63/08

(52) U.S. Cl. CPC C08J 5/24; C08L 63/08; C08L 63/00; C08L 63/04; C08J 2363/10; C08J 2363/04; C08L 2201/02; C08L 2203/20

(57) ABSTRACT

The present invention discloses a thermosetting resin composition, which comprises epoxy resin with 2 or more than 2 epoxy groups in each resin molecule; and active ester containing styrene structure. The thermosetting resin composition is used to prepare resin sheet, resin composite metal copper foil, prepreg, laminate, copper clad laminate, printed circuit board and the like. The thermosetting resin composition significantly reduces the probability of delamination in PCB substrate, and the obtained resin composition has excellent thermal stability and moisture-heat resistance, low dielectric constant and dielectric loss angle tangent, and excellent flame retardancy.

### TECHNICAL FIELD

The present invention relates to a resin composition, particularly relates to a thermosetting resin composition and its usage in resin sheet, resin composite metallic foil, prepreg, laminate, metal clad laminate and printed circuit board.

### BACKGROUND ART

In recent years, with the development of intendancy of high performance, high function and network of computer and information communication equipment, in order to transmit and process large load of information in high speed, the operation signals intend to be of high frequency, therefore new requirements were put forward on the development of the circuit board towards the direction of high multilayer and high wiring density, and the substrate material used. These requirements include: 1, good dielectric properties (low dielectric constant and low dielectric loss angle tangent), and keeping stable in a wide range of temperature and frequency; 2, being resistant to shock of acid and alkali, high temperature and high humidity environment in PCB process, without swelling for moisture absorption and the consequent lamination rupture; 3, suitable for processing and installation requirements under high temperatures; 4, good safety of flame retardant.

However, among the current materials for preparation of printed circuit board, binders with epoxy resin as main part are widely used. The ordinary epoxy resin circuit board (FR-4 board) has the main components of low brominated or high brominated epoxy resin prepared with bisphenol A epoxy resin or tetrabromobisphenol A epoxy resin, and curing agent dicyandiamide, solvent and catalyst are added in preparation. The ordinary epoxy resin circuit board (FR-4 copper clad laminate) can meet most of the requirements of the printed circuit, but the ordinary epoxy resin circuit board (FR-4 copper clad laminate) has too low glass transition temperature (Tg), poor heat resistance and high dielectric constant and dielectric loss angle tangent (dielectric constant 4.4, dielectric loss angle tangent about 0.02), thus its high frequency property is insufficient and cannot adapt to the requirement of intendancy of high frequency of signal. In order to make the epoxy resin meet the usage requirements as much as possible after curing, the researchers in the prior art adopted curing agents with low polarity, such as styrene maleic anhydride copolymer (SMA) or other curing agents with low polarity, to modify the epoxy resin to improve its high frequency dielectric properties and heat resistance. These research results will be further discussed in the following.

BE627887 discloses an epoxy resin composition wherein the styrene maleic anhydride copolymer (SMA, structural formula thereof is as follows) is used as the epoxy resin crosslinking agent. This epoxy resin composition has the disadvantage of poor thermal stability, thus it is not suitable to be used in the substrate copper clad laminate of multilayer printed circuit board (PCB).

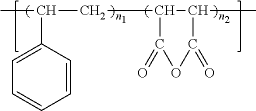

Addressing the ordinary epoxy resin circuit board (FR-4 board), which has the main components of low brominated or high brominated epoxy resin prepared with bisphenol A epoxy resin or tetrabromobisphenol A epoxy resin, is prepared with addition of curing agent dicyandiamide, solvent and catalyst, and has the disadvantage of low glass transition temperature Tg (120-140° C.) and poor heat resistance, the researchers in the prior art usually adopted multifunctional epoxy resin to replace difunctional epoxy resin, or adopted phenolic resin to replace dicyandiamide, in order to increase curing crosslinking density to improve the glass transition temperature, and improve the heat resistance, but this method can not improve the high-frequency electrical properties of board.

U.S. Pat. No. 6,509,414 adopted styrene maleic anhydride copolymer as curing agent, tetrabromobisphenol A, tetrabromobisphenol A epoxy resin or their mixture as co-curing agent for FR-4 epoxy resin curing to improve the glass transition temperature and thermal stability. But the styrene maleic anhydride copolymer in the composition is brittle, thus the prepared prepreg (for preparing printed circuit board) is fairly brittle. In cutting, the resin on the edge of the prepreg is easy to dust, which is sometimes referred to as “mushroom effect” and would bring hidden quality danger to the processing technology. Furthermore, there are two hydroxy with very large polarity in the tetrabromobisphenol A molecular structure, thus the introduction of tetrabromobisphenol A has deteriorated the dielectric properties of the system to a certain extent.

In U.S. Pat. No. 6,667,107, difunctional cyanate ester and its self-polymer, styrene maleic anhydride and its derivative and epoxy resin etc. are adopted to prepare a kind of copper clad laminate composition with low dielectric constant and dielectric loss angle tangent. In the copper clad laminate composition, cyanate ester resin and styrene maleic anhydride and its derivatives were co-adopted to improve the glass transition temperature of the epoxy resin system, and it has excellent dielectric properties of high frequency, but the molecular structure of the styrene maleic anhydride copolymer adopted in this system has anhydride groups, which can generate carboxyl groups with poor thermal stability and moisture-heat resistance; as it is adopted in concert with cyanate ester which has poor moisture-heat resistance, the moisture-heat resistance is further deteriorated. Addition of epoxy resin has improved the moisture-heat resistance properties in a certain extent, but the improvement is limited and the problem cannot be eliminated fundamentally, therefore in preparation process of PCB, the boards are susceptible to etch of moisture and develop delamination, and the product qualified rate is very low.

The Japanese Patent Publication 2003-252958 discloses a kind of biphenyl epoxy resin and active ester composition, which has excellent dielectric constant and dielectric loss angle tangent after curing. But it is a kind of bifunctional biphenyl epoxy resin that is adopted, which has low crosslinking density with the active ester; therefore it has the disadvantage of low glass transition temperature and low heat resistance of the cured products.

In the Japanese Patent Publication 2009-235165, active ester cured epoxy resin with structural formula Y and no styrene structure is adopted, and cured product with higher glass transition temperature can be obtained:

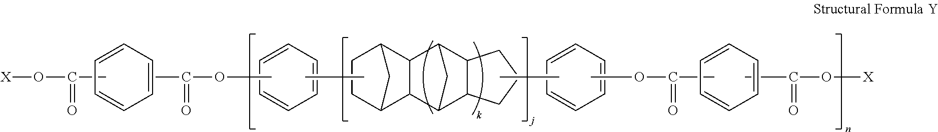

wherein, X is a benzene ring or naphthalene ring, j is 0 or 1, k is 0 or 1, n represents the average repeated unit for 0.25-1.25. But for the application fields with more demanding requirements for dielectric performance, the dielectric constant is needed to be further reduced for the cured products of the active ester and epoxy resin.

### SUMMARY OF THE INVENTION

To solve the above problems, the object of the present invention is to provide a kind of thermosetting epoxy resin composition with active ester containing styrene structure, which has good moisture-heat resistance, low dielectric constant and dielectric loss angle tangent, and good flame retardant.

The object of the present invention is also to provide a prepreg and printed circuit board prepared with the thermosetting epoxy resin composition of active ester containing styrene structure, which has the advantage of good moisture-heat resistance, and low dielectric constant and dielectric loss angle tangent, and also has high glass transition temperature and good thermal stability and flame retardant.

In order to attain the above object, the present invention in the first aspect provides a thermosetting resin composition, which comprises epoxy resin with 2 or more epoxy groups in each resin molecular; and the active ester containing styrene structure.

Preferably, the epoxy resin with 2 or more epoxy groups in each resin molecule are such as glycidyl ether type epoxy resin, glycidyl ester type epoxy resin, glycidyl amine type epoxy resin, linear aliphatic type epoxy resin and alicyclic type epoxy resin. Glycidyl ester type epoxy resin includes such as diglycidyl phthalate, diglycidyl tetrahydrophthalate, diglycidyl hexahydrophthalate and the like. Glycidyl amine type epoxy resin comprises such as 4,4′-diaminodiphenylmethane tetraglycidyl amine (TGDDM), triglycidyl para-aminophenol (TGPAP) and the like. Alicyclic type epoxy resin comprises such as ERL-4221, ERL-4221D and ERL-4299 of Dow Chemical. The epoxy resin can be used alone, and also can be used in blending.

Preferably, the epoxy resin is one or a mixture of at least two of the following epoxy resin:

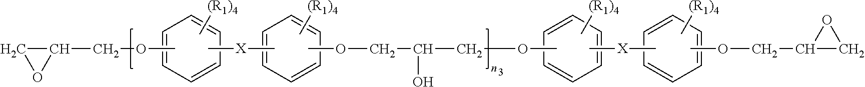

wherein R₁ is selected from the group consisting of hydrogen atom, halogen atom, a substituted or unsubstituted C1-C8 straight chain alkyl, substituted or unsubstituted C1-C8 branched alkyl, substituted or unsubstituted alicyclic alkyl, substituted or unsubstituted C1-C10 alkoxy, substituted or unsubstituted phenyl; n₃ is any natural number; X is any one selected from the group consisting of —CH₂—, —O—, —CO—, —SO₂—, —S—, —CH(C₆H₅)—, —C(C₆H₅)₂—, —CH(CH₃)—, —C(CH₃)₂— or

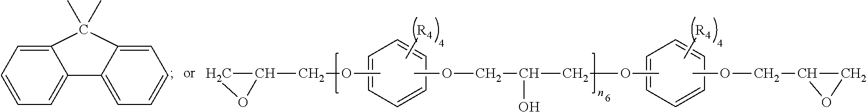

wherein R₄ is selected from the group consisting of hydrogen atom, halogen atom, a substituted or unsubstituted C1-C8 straight chain alkyl, substituted or unsubstituted C1-C8 branched alkyl, substituted or unsubstituted alicyclic alkyl, substituted or unsubstituted C1-C10 alkoxy and substituted or unsubstituted phenyl; n₆ is any natural number; or
phenol novolac type epoxy resin; methyl phenol novolac type epoxy resin; bisphenol A type novolac epoxy resin; dicyclopentadiene epoxy resin; biphenyl epoxy resin; resorcinol type epoxy resin; naphthalene based epoxy resin; phosphorus containing epoxy resin; silicon containing epoxy resin; glycidyl amine type epoxy resin; cycloaliphatic epoxy resin; polyethylene glycol type epoxy resin; tetraphenol ethane tetraglycidyl ether; triphenyl glycidyl ether methane type epoxy resin. The mixture is such as the mixture of methyl phenol novolac type epoxy resin and tetraphenol ethane tetraglycidyl ether, the mixture of triphenolic methane type epoxy resin and polyethylene glycol type epoxy resin, the mixture of resorcinol epoxy resin and cycloaliphatic epoxy resin, the mixture of naphthalene based epoxy resin and biphenyl epoxy resin, the mixture of bisphenol F type epoxy resin and bisphenol A type epoxy resin.

Preferably, the epoxy resin is one or a mixture of at least two selected from the epoxy resin with the following structure,

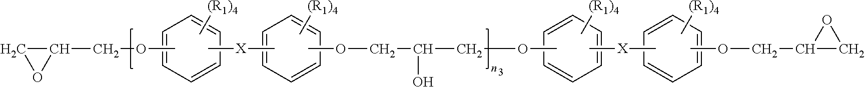

wherein R₁ is selected from the group consisting of hydrogen atom, halogen atom, a substituted or unsubstituted C1-C8 straight chain alkyl, substituted or unsubstituted C1-C8 branched alkyl, substituted or unsubstituted alicyclic alkyl, substituted or unsubstituted C1-C10 alkoxy and substituted or unsubstituted phenyl; n₃ is any natural number; X is any one selected from the group consisting of —CH₂—, —O—, —CO—, —SO₂—, —S—, —CH(C₆H₅)—, —C(C₆H₅)₂—, —CH(CH₃)—, —C(CH₃)₂— or

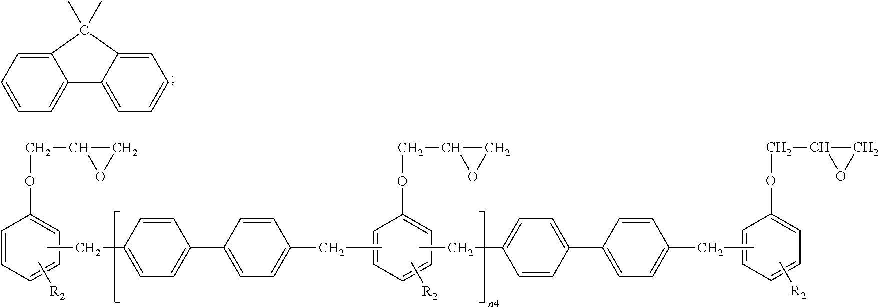

wherein R₂ is selected from the group consisting of hydrogen atom, a substituted or unsubstituted C1-C8 straight chain alkyl, substituted or unsubstituted C1-C8 branched alkyl, substituted or unsubstituted alicyclic alkyl, substituted or unsubstituted C1-C10 alkoxy and substituted or unsubstituted phenyl; 0 [symbol] n₄ [symbol] 20, and n₄ is an integer;

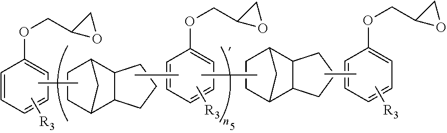

wherein R₃ is selected from the group consisting of hydrogen atom, a substituted or unsubstituted C1-C8 straight chain alkyl, substituted or unsubstituted C1-C8 branched alkyl, substituted or unsubstituted alicyclic alkyl, substituted or unsubstituted C1-C10 alkoxy, and substituted or unsubstituted phenyl; 0 [symbol] n₅ [symbol] 20, and n₅ is an integer;

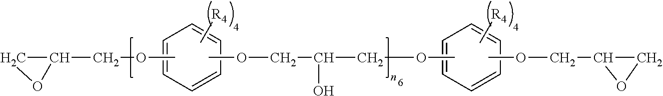

wherein R₄ is selected from the group consisting of hydrogen atom, a substituted or unsubstituted C1-C8 straight chain alkyl, substituted or unsubstituted C1-C8 branched alkyl, substituted or unsubstituted alicyclic alkyl, substituted or unsubstituted C1-C10 alkoxy and substituted or unsubstituted phenyl; n₆ is any natural number; or

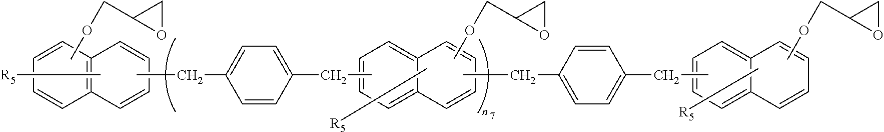

wherein R₅ is selected from the group consisting of hydrogen atom, substituted or unsubstituted C1-C8 straight chain alkyl, substituted or unsubstituted C1-C8 branched alkyl, substituted or unsubstituted alicyclic alkyl, substituted or unsubstituted C1-C10 alkoxy and substituted or unsubstituted phenyl; 0 [symbol] n₇ [symbol] 20 and n₇ is an integer. Preferably, the active ester containing styrene structure has the following structure:

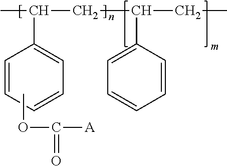

wherein A is substituted or unsubstituted phenyl, substituted or unsubstituted naphthyl, C1-C8 alkyl; m and n are natural numbers, m/n=0.8-19. When m/n is larger than 19, the peeling strength of the board is too low and hidden quality danger such as line dropping is easy to occur in PCB processing; when m/n is smaller than 0.8, the dielectric property of the board will be deteriorated. Concerning the balance of dielectric constant, dielectric loss angle tangent, glass transition temperature, solder resistance and peeling strength, m/n is preferably 1-8.

Preferably, considering the balance of the dielectric constant, dielectric loss angle tangent, glass transition temperature, solder resistance and peeling strength, the active ester accounts for 10-70 wt % of the total weight of the thermosetting resin composition, such as 11 wt %, 15 wt %, 17 wt %, 19 wt %, 23 wt %, 25 wt %, 27 wt %, 29 wt %, 35 wt %, 37 wt %, 40 wt %, 45 wt %, 50 wt %, 55 wt %, preferably 15-65 wt %, more preferably 15-60 wt %.

Preferably, the composition of the present invention also comprises a flame retardant, preferably halogen-based flame retardant and/or phosphorus-based flame retardant.

Preferably, the halogen-based flame retardant is one or a mixture of at least two selected from the group consisting of bromophenol, brominated bisphenol A, decabromodiphenyl ether, brominated polystyrene, brominated polycarbonate, decabromodiphenyl ethane and N,N-ethylene-bis(tetrabromophthalimide). The mixture is such as the mixture of N,N-ethylene-bis(tetrabromophthalimide) and decabromodiphenyl ethane, the mixture of brominated polycarbonate and hexabromobenzene, the mixture of decabromodiphenyl ether and N,N-ethylene-bis(tetrabromophthalimide), and the mixture of decabromodiphenyl ethane and brominated polycarbonate. The brominated flame retardant can be used alone, and also can be used in blending.

Preferably, the phosphorus-based flame retardant is one or a mixture of at least two selected from the group consisting of tri(2,6-dimethylphenyl)phosphine, tetrakis(2,6-dimethylphenyl) 1,3-phenylene bisphosphate, etraphenyl resorcinol diphosphate, triphenyl phosphate, bisphenol-A bis(diphenyl phosphate), Phosphazene flame retardant, 10-(2,5-dihydroxyphenyl)-10-hydro-9-xa-10-phosphaphenanthrene-10-oxide, 10-(2,5-dihydroxynaphthyl)-10-hydro-9-xa-10-phosphaphenanthrene-10-oxide or 9,10-dihydro-9-xa-10-phosphaphenanthrene-10-oxide flame retardant.

The inorganic flame retardant used in concert with the organic additive type flame retardant is one or a mixture of at least two selected from the group consisting of red phosphorus, aluminum hydroxide, magnesium hydroxide and antimony trioxide. The mixture is such as the mixture of antimony trioxide and magnesium hydroxide, the mixture of aluminum hydroxide and red phosphorus, the mixture of antimony trioxide and aluminum hydroxide, the mixture of magnesium hydroxide and red phosphorus, the mixture of antimony trioxide, magnesium hydroxide and aluminum hydroxide, and the mixture of red phosphorus, antimony trioxide, magnesium hydroxide and aluminum hydroxide.

Preferably, the additive type flame retardant accounts for 5-30 wt % of the total weight of the thermosetting resin composition, such as 7 wt %, 9 wt %, 11 wt %, 13 wt %, 15 wt %, 17 wt %, 19 wt %, 21 wt %, 23 wt %, 25 wt %, 27 wt %, 29 wt %, preferably 10-30 wt %, more preferably 10-25 wt %.

Preferably, the thermosetting resin also comprises filler.

Preferably, the filler is any one or a mixture of at least two selected from the group consisting of aluminum hydroxide, magnesium hydroxide, kaolin, talcum powder, hydrotalcite, calcium silicate, beryllium oxide, boron nitride, glass powder, silicon powder, zinc borate, aluminum nitride, silicon nitride, silicon carbide, magnesium oxide, zirconium oxide, mullite, titanium dioxide, potassium titanate, hollow glass bead, potassium titanate fiber, silicon carbide monocrystalline fiber, silicon nitride fiber, aluminum oxide monocrystalline fiber, short glass fiber, polytetrafluoroethylene powder, polyphenylene sulfide powder and polystyrene powder. The mixture is such as the mixture of aluminum hydroxide and magnesium hydroxide, the mixture of kaolin and hydrotalcite, the mixture of calcium silicate and beryllium oxide, the mixture of boron nitride and glass powder, the mixture of silicon powder and zinc borate, the mixture of aluminum nitride and silicon nitride, the mixture of silicon carbide and magnesium oxide, the mixture of zirconium oxide and mullite, the mixture of titanium dioxide and potassium titanate, the mixture of hollow glass bead and potassium titanate fiber, the mixture of silicon carbide monocrystalline fiber and silicon nitride fiber, the mixture of aluminum oxide monocrystalline fiber and short glass fiber, the mixture of polytetrafluoroethylene powder and polyphenylene sulfide powder. The filler can be used alone, and also can be used in blending.

Preferably, the filler accounts for 5-60 wt % of the total weight of the thermosetting resin composition, such as 12 wt %, 15 wt %, 18 wt %, 21 wt %, 25 wt %, 27 wt %, 32 wt %, 35 wt %, 38 wt %, 42 wt %, 45 wt %, 48 wt %, 52 wt %, 54 wt %, 56 wt %, 58 wt %, preferably 15-55 wt %, more preferably 20-40 wt %.

In the thermosetting resin composition of the present invention, catalyst can also be added.

Preferably, the catalyst is one or a mixture of at least two selected from the group consisting of tertiary amine, tertiary phosphine, quaternary ammonium salt, quaternary phosphonium salt and imidazole compound.

Preferably, the tertiary amine is any one or a mixture of at least two selected from the group consisting of triethylamine, tributylamine, dimethylethanolamine, N,N-dimethylamino pyridine and phenmethyl dimenthylamine.

Preferably, the tertiary phosphine is selected from triphenylphosphine and trialkyl phosphine

Preferably, the quaternary ammonium salt is any one or a mixture of at least two selected from the group consisting of tetramethylammonium bromide, tetramethylammonium chloride, tetramethylammonium iodide, benzyltrimethylammonium chloride, benzyltriethylammonium chloride and hexadecyl trimethyl ammonium bromide. The mixture is such as the mixture of hexadecyl trimethyl ammonium bromide and benzyltriethylammonium chloride, the mixture of benzyltrimethylammonium chloride and tetramethylammonium iodide, the mixture of tetramethylammonium chloride and tetramethylammonium bromide, the mixture of hexadecyl trimethyl ammonium bromide, benzyltriethylammonium chloride and benzyltrimethylammonium chloride, the mixture of tetramethylammonium iodide, tetramethylammonium chloride and tetramethylammonium bromide.

Preferably, the quaternary phosphonium salt is any one or a mixture of at least two selected from the group consisting of tetrabutylphosphonium chloride, tetrabutylphosphonium bromide, tetrabutylphosphonium iodide, tetraphenylphosphonium chloride, tetraphenylphosphonium bromide, tetraphenylphosphonium iodide, ethyl-triphenylphosphonium chloride, propyltriphenylphosphonium chloride, propyltriphenylphosphonium bromide, propyltriphenylphosphonium iodide, butyltriphenylphosphonium chloride, butyltriphenylphosphonium bromide, butyltriphenylphosphonium iodide. The mixture is such as the mixture of butyltriphenylphosphonium chloride and propyltriphenylphosphonium bromide, the mixture of propyltriphenylphosphonium chloride and ethyl-triphenylphosphonium chloride, the mixture of tetraphenylphosphonium iodide and tetraphenylphosphonium bromide, the mixture of tetraphenylphosphonium chloride and tetrabutylphosphonium iodide, the mixture of tetrabutylphosphonium bromide and tetrabutylphosphonium chloride, the mixture of butyltriphenylphosphonium chloride, propyltriphenylphosphonium chloride and tetraphenylphosphonium iodide.

Preferably, the imidazole compound is one or a mixture of at least two selected from the group consisting of 2-methylimidazole, 2-ethyl-4-methylimidazole, 2-phenylimidazole, 2-undecylimidazole, 1-benzyl-2-methylimidazole, 2-heptadecylimidazole, 2-isopropylimidazole, 2-phenyl-4-methylimidazole, 2-dodecylimidazole and cyanoethyl-2-methylimidazole. The mixture is such as the mixture of cyanoethyl-2-methylimidazole and 2-phenyl-4-methylimidazole, the mixture of 2-isopropylimidazole and 2-heptadecylimidazole, the mixture of 1-benzyl-2-methylimidazole and 2-undecylimidazole, the mixture of 2-phenylimidazole and 2-ethyl-4-methylimidazole, and the mixture of 2-methylimidazole and 2-heptadecylimidazole.

The usage amount of catalyst depends on the type of epoxy resin, curing agent and catalyst. A principle of using the catalyst is the gelation time of varnish should not be less than 120s. The dosage of catalyst in the present invention is 0.001-5.0 wt % of the total weight of the thermosetting resin composition, preferably 0.05-4.0 wt %, more preferably 0.05-3.0 wt %. Over-dosage of the catalyst (more than 5.0 wt %) will cause the reaction of the epoxy resin composition to be too fast, and have adverse effects on uniformity of by-product formation and conversion rate of curing reaction; if the usage amount of catalyst in composition is lower than 0.001 wt %, reaction will be too slow, which is not good for the prepreg preparation.

In the thermosetting resin composition of the present invention, catalyst can also be added.

Preferably, the solvent is one or a mixture of at least two selected from the group consisting of ketones, hydrocarbons, ethers, esters and aprotic solvent, preferably acetone, methyl ethyl ketone, methyl isobutyl ketone, toluene, xylene, methanol, ethanol, primary alcohol, 2-methoxyethanol, Propylene glycol monomethyl ether, acetic ether, N,N-dimethylformamide or N,N-diethylformamide. The solvent can be used alone, and also can be used in blending. The addition amount of the solvent can be determined by the skilled person in the prior art according to the viscosity of the selected resin, to make the viscosity of the obtained epoxy resin varnish moderate, easy to cure. This is not limited in the present invention.

Preferably, the thermosetting resin composition also comprises any one or a mixture of at least two selected from the group consisting of polyphenylene ether, cyanate resin or BT resin.

Preferably, the cyanate resin is prepared from any one or a mixture of at least two of the following monomers, any one or a mixture of at least two of the prepolymer of the following monomers, or a mixture of any one or at least two of the following monomers with any one or at least two of the prepolymer of the following monomers: bisphenol-A cyanate, 2,2-Bis(4-cyanatophenyl)propane, Bis(4-cyanatophenyl)ethane, Bis(4-cyanatophenyl)methane, bis(4-cyanato-3,5-dimethylphenyl) methane, 2,2-bis(4-cyanatophenyl) Hexfluoropropane, bis(4-cyanatophenyl) sulfoether, novolac cyanate resin and cyanate ester containing dicyclopentadiene structure.

Preferably, the thermosetting resin composition may also contain polyphenylene ether (PPO).

Preferably, the thermosetting resin composition may also contain rubber or rubber modification compound such as styrene/butadiene copolymer, the copolymer of butadiene/styrene and methyl methacrylate or other vinyl compound, core-shell rubber particle of methyl methacrylate/butadiene/styrene or its modified epoxy resin, and rubber modified epoxy or phenoxy resin such as CTBN.

Preferably, the thermosetting resin composition may comprise any one or a mixture of at least two selected from the group consisting of dyes, pigments, surfactant, leveling agent and UV absorber.

The present invention in the second aspect provides resin sheet, resin composite metal foil, prepreg, laminate, copper clad laminate and printed circuit board prepared with the thermosetting resin composition described above.

The present invention in the third aspect provides the application of thermosetting resin composition described above in preparation of resin sheet, resin composite metal foil, prepreg, laminate, copper clad laminate and printed circuit board.

The preparation method of resin sheet with the thermosetting resin composition of the present invention is listed as follows, but the resin sheet preparation method is not limited to this. The thermosetting resin composition is coated on the carrier film, wherein the carrier film can be polyester film or polyimide film and the thickness of carrier film is 5-150 μm, such as 10 μm, 15 μm, 20 μm, 25 μm, 30 μm, 35 μm, 40 μm, 45 μm, 50 μm, 55 μm, 60 μm, 70 μm, 80 μm, 90 μm, 100 μm, 105 μm, 110 μm, 115 μm. Then the carrier film coated with thermosetting resin composition is heated under 100-250° C. (such as 110° C., 120° C., 130° C., 140° C., 150° C., 160° C., 170° C., 180° C., 190° C., 200° C., 210° C., 220° C., 240° C.) for 10 seconds to 30 minutes, forming board. For example, it can be heated for 30s, 60s, 3 min, 5 min, 8 min, 11 min, 15 min, 18 min, 21 min, 24 min, 27 min, 29 min. The thickness of the formed resin sheet is 5-100 μm, such as 10 μm, 15 μm, 20 μm, 25 μm, 30 μm, 35 μm, 40 μm, 45 μm, 50 μm, 55 μm, 60 μm, 70 μm, 80 μm, 90 μm etc.

The preparation method of resin composite metal foil with the thermosetting resin composition of the present invention is listed as follows, but the preparation method of the resin composite metal foil is not limited to this. For the metal foil, one or a mixture of at least two selected from the group consisting of copper, brass, aluminum and nickel can be used. In the metal foil, the alloy containing the above metals can also be used. The thickness of the metal foil is 5-150 μm, such as 10 μm, 15 μm, 20 μm, 25 μm, 30 μm, 35 μm, 40 μm, 45 μm, 50 μm, 55 μm, 60 μm, 70 μm, 80 μm, 90 μm, 100 μm, 105 μm, 110 μm, 115 μm. The thermosetting resin composition is coated onto the above metal foil through the manual or mechanical roller coating device. Then the metal foil coated with thermosetting resin composition is heated and dried, to make the thermosetting resin composition in a semi-cured state (B-Stage). Then it is heated under the temperature of 100-250° C. (such as 110° C., 120° C. 130° C. 140° C. 150° C., 160° C. 170° C. 180° C. 190° C. 200° C. 210° C. 220° C., 240° C.) for 10 seconds to 30 minutes (such as 30s, 60s, 3 min, 5 min, 8 min, 11 min, 15 min, 18 min, 21 min, 24 min, 27 min, 29 min) for curing. The thickness of the finally formed resin layer of the resin composite metal is 1-150 μm. The resin composite metal copper foil (RCC) obtained in this method can be used as inner or outer layer of a printed circuit board for adding layers to the printed circuit board.

The preparation method of the prepreg from the thermosetting resin composition of the present invention is listed as follows, but the preparation method of prepreg is not limited to this. The thermosetting resin composition varnish is impregnated on the reinforcer, and the prepreg impregnated with the thermosetting resin composition is heated and dried to make the thermosetting resin composition in the prepreg in the semi-curing stage (B-Stage), thus the prepreg can be obtained. The heating temperature is 80-250° C., such as 90° C., 100° C., 110° C., 120° C., 130° C., 140° C., 150° C., 160° C., 170° C., 180° C., 190° C., 200° C., 210° C., 220° C., 230° C., 240° C. The heating time is 1-30 min, such as 3 min, 5 min, 7 min, 10 min, 13 min, 16 min, 19 min, 22 min, 25 min, 28 min, 29 min. The used reinforcer can be inorganic or organic materials. The inorganic materials are listed as woven fabric such as glass fiber, carbon fiber, boron fiber, metal etc., or non-woven fabric or paper. The glass fiber cloth or non-woven fabric can be E-glass, Q type cloth, NE cloth, D type cloth, S type cloth, high silica cloth etc. The woven fabric prepared from the organic fiber such as polyester, polyurethane, polyacrylic acid, polyimide, aramid fiber, polytetrafluoroethylene, syndiotactic polystyrene and other or non-woven fabrics or paper. However, the reinforce are not limited to these, and the other reinforcer which can be used for resin reinforcement can also be used to attain the present invention. The content of resin in the prepreg is between 25-70 wt %.

The above resin sheet, resin composite metal foil and prepreg can be used to prepare laminate, copper clad laminate and printed circuit board.

The preparation method of laminate from the prepreg of the present invention is as follows: at least two layers of the prepreg are stacked, and are hot-pressed under a temperature of 130-250° C., a pressure of 3-50 kgf/cm², for 60-240 min to form and obtain a laminate. The hot pressing temperature is 130-250° C., such as 140° C., 150° C., 160° C., 170° C., 180° C., 190° C., 200° C., 210° C., 220° C., 230° C., 240° C. The pressure is 3-50 kgf/cm², such as 5 kgf/cm², 8 kgf/cm², 11 kgf/cm², 14 kgf/cm², 17 kgf/cm², 24 kgf/cm², 28 kgf/cm², 32 kgf/cm², 37 kgf/cm², 42 kgf/cm², 45 kgf/cm², 48 kgf/cm². The time of hot pressing is 60-240 min, such as 70 min, 90 min, 110 min, 130 min, 150 min, 170 min, 190 min, 210 min, 230 min, 240 min. The preparation method of metal clad laminate from the prepreg of the present invention is shown as follows: one or more prepregs are cut into certain size, and then stacked and sent into the laminating equipment for laminating. At the same time, the metal foil is placed on one side or both sides of the prepreg. The prepreg is pressed by hot-press molding to form metal clad laminate. For the metal foil, one or a mixture of at least two selected from the group consisting of copper, brass, aluminum or nickel can be used. The alloy containing the above metals can also be used for the metal foil. For the pressing conditions of a laminate, appropriate laminate curing conditions can be selected according to the actual situation of the epoxy resin composition. If the pressing pressure is too low, voids will exist between the laminates and its electrical performance will decline; if the laminating pressure is too large, there are too much internal stress exists between laminates, and the dimensional stability properties of the laminates will decline. For all these situations, appropriate molding pressure is needed for plate pressing to meet the requirements. The general guiding principle for the regular laminate pressing is, the laminating temperature of 130-250° C., pressure: 3-50 kgf/cm², time of hot pressing: 60-240 min. The hot pressing temperature is 130-250° C., such as 140° C., 150° C., 160° C., 170° C., 180° C., 190° C., 200° C., 210° C., 220° C., 230° C., 240° C. The pressure is 3-50 kgf/cm², such as 5 kgf/cm², 8 kgf/cm², 11 kgf/cm², 14 kgf/cm², 17 kgf/cm², 24 kgf/cm², 28 kgf/cm², 32 kgf/cm², 37 kgf/cm², 42 kgf/cm², 45 kgf/cm², 48 kgf/cm². The time of hot pressing time is 60-240 min, such as 70 min, 90 min, 110 min, 130 min, 150 min, 170 min, 190 min, 210 min, 230 min, 240 min.

The resin sheet, resin composite metal foil, prepreg and metal clad laminate can be used to prepare printed circuit board or complex multi-layer circuit board by additive process or subtractive process method. The preparation method of printed circuit board from the prepreg of the present invention is as follows: the metal clad laminate is prepared by the method mentioned above, and the printed circuit board or complex multi-layer circuit board is prepared by the additive process or subtractive process method.

The thermosetting resin composition varnish is liquid varnish obtained by adding solvent to the composition and adjusting the solvent.

The thermosetting resin composition of the present invention can not only be used for preparation of the resin sheet, resin composite metal foil, prepreg, laminate, metal clad laminate, printed circuit board, but also be used for the preparation of adhesives, coatings, and also for construction, aviation, shipbuilding and automobile industry.

The term of “comprise” in the present invention means that in addition to the mentioned components, it may also comprise other components, which give the thermosetting resin composition with different properties. Regardless of the components comprised in the thermosetting resin composition of the present invention, excluding solvents, the sum of weight percentage of each component in the thermosetting resin composition is 100%.

Compared with the prior art, the present invention has the following beneficial effects:

In the present invention, the active ester with styrene structure is selected as curing agent. The active ester does not generate polar group hydroxyl when curing epoxy resin, thus it has excellent dielectric loss angle tangent; at the same time the active ester has styrene structure with low polarity, thus it can further reduce the dielectric constant and water absorption rate after curing of the active ester and the thermosetting resin composition, when compared with the active ester without styrene structure in the background patent; in addition, the active ester has multifunctionality, thus the crosslinking density after its curing with epoxy resin is appropriate, higher glass transition temperature can be obtained, and it has excellent thermal stability, moisture-heat resistance and heat resistance; the thermosetting resin composition of the present invention has excellent thermal stability and moisture-heat resistance, and low dielectric constant and dielectric loss angle tangent.

### SPECIFIC EMBODIMENTS

For better illustrating the present invention and understanding of the technical solution of the present invention, the typical but non-limiting embodiments of the present invention are described in the following:

### Example 1

35 parts of active ester containing styrene structure (m/n=8 1, SHINA production, model number: SAP820), 30 parts of HP7200, 15 parts of BT93, 20 parts of SC2050, 0.1 parts of 2-MI catalyst are dissolved with MEK, and prepared into varnish with appropriate viscosity. 2116 style electronic glass cloth is infiltrated with the varnish, and then deprived of the solvent in the oven of 155° C. to obtain the prepreg specimen of B-stage. The sum of weight parts of active ester with styrene structure, HP7200, BT93 and SC2050 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 1 for the corresponding properties.

### Example 2

50 parts of active ester 1 containing styrene structure (m/n=8 1, SHINA production, model number: SAP820), 25 parts of EPPN501H epoxy resin, 20 parts of SAYTEX8010 decabromodiphenyl ethane, 5 parts of kaolin, and 0.075 parts of catalyst N,N-dimethylaminopyridine are dissolved with toluene and prepared into varnish with appropriate viscosity. Polyester nonwoven is infiltrated with the varnish, and then deprived of the solvent in the oven of 155° C. to obtain the prepreg specimen of B-stage. The sum of weight parts of active ester with styrene structure, EPPN501H epoxy resin, decabromodiphenyl ethane and kaolin is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 1 for the corresponding properties.

### Example 3

60 parts of active ester containing styrene structure 1(m/n=8, SHINA production, model number: SAP820), 30 parts of AG-80 epoxy resin, 10 parts of polytetrafluoroethylene powder and 0.1 parts of catalyst butyltriphenylphosphonium chloride are dissolved by DMF, and prepared into varnish with appropriate viscosity. 2116 style electronic glass cloth is infiltrated with this varnish, and then deprived of solvent in the oven of 155° C. to obtain the prepreg specimen of B-stage. The sum of weight parts of the active ester with styrene structure, AG-80 epoxy resin and polytetrafluoroethylene powder is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 1 for the corresponding properties.

### Example 4

30 parts of active ester 2 containing styrene structure (m/n=1), 35 parts of N695, 15 parts of BT93 (N,N-ethylene-bis(tetrabromophthalimide)), 20 parts of SC2050 and 0.1 parts of catalyst 2-MI (2-methyl imidazole) are dissolved with MEK (butanone), and prepared into varnish with appropriate viscosity. 2116 style electronic glass cloth is infiltrated with this varnish, and deprived of solvent in the oven of 155° C. to obtain the prepreg specimen of B-stage. The sum of weight parts of active ester containing styrene structure, N695, BT93 and SC2050 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 1 for the corresponding properties.

### Example 5

40 parts of active ester 3 containing styrene structure (m/n=6, SHINA production), 25 parts of NC7700L, 15 parts of BT93, 20 parts of SC2050 and 0.1 parts of catalyst 2-MI are dissolved by MEK, and prepared into varnish with appropriate viscosity. 2116 style electronic glass cloth is infiltrated with the varnish, and then deprived of solvent in the oven of 155° C., to obtain the prepreg specimen of B-stage. The sum of weight parts of active ester containing styrene structure, HP7200, BT93 and SC2050 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 1 for the corresponding properties.

### Example 6

15 parts active ester 4 containing styrene structure (m/n=15), 25 parts HF-10, 25 parts N695, 15 parts HP3010, 20 parts SC2050, 0.02 parts catalyst 2-MI and 0.1 parts zinc octoate are dissolved by MEK, and prepared into varnish with appropriate viscosity. 2116 style electronic glass cloth is infiltrated with this varnish, and then deprived of solvent in the oven of 155° C. to obtain the prepreg specimen of B-stage. The sum of weight parts of active ester containing styrene structure, HF-10, N695, HP3010 and SC2050 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 1 for the corresponding properties.

### Comparative Example 1

3.5 parts dicyandiamide, 96.5 parts DER530 and 0.05 parts catalyst 2-MI are dissolved by MEK, and then prepared into varnish with appropriate viscosity. 2116 style electronic glass cloth is infiltrated with this varnish, and deprived of solvent in the oven of 155° C., to obtain the prepreg specimen of B-stage. The sum of the dicyandiamide and DER530 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 2 for the corresponding properties.

### Comparative Example 2

75 parts active ester 5 containing styrene structure (m/n=25), 25 parts DER530 and 0.1 parts catalyst 2-MI are dissolved by MEK, and prepared into varnish with appropriate viscosity. 2116 style electronic glass cloth is infiltrated with this varnish, and deprived of solvent in the oven of 155 degree to obtain prepreg specimen of B-stage. The sum of weight parts of active ester containing styrene structure and DER530 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 2 for the corresponding properties.

### Comparative Example 3

10 parts active ester 6 containing styrene structure (m/n=0.5), 10 parts N695, 35 parts DER530, 20 parts SPB100, 25 parts SC2050 and 0.1 parts catalyst 2-MI are dissolved by MEK, and prepared into varnish with appropriate viscosity. 2116 style electronic glass is infiltrated with the varnish, and deprived of solvent in the oven of 155° C. to obtain prepreg specimen of B-stage. The sum of the weight parts of the active ester and N695 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 2 for the corresponding properties.

### Comparative Example 4

25 parts TD2090, 35 parts N695, 15 parts BT93, 20 parts SC2050, 0.05 parts catalyst 2-MI and zinc caprylate are dissolved by MEK, and prepared into varnish with appropriate viscosity. 2116 style electronic glass cloth is infiltrated with this varnish, and deprived of solvent in the oven of 155° C., to obtain the prepreg specimen of B-stage. The sum of the weight parts of SMA, active ester, N695, BT93 and SC2050 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 2 for the corresponding properties.

### Comparative Example 5

35 parts HPC-8000-T65, 30 parts HP7200, 15 parts BT93, 20 parts SC2050 and 0.1 parts catalyst 2-MI are dissolved by MEK, and prepared into varnish with appropriate viscosity. 2116 style electronic glass cloth is infiltrated with the varnish, and deprived of solvent in the oven of 155° C., obtain the prepreg specimen of B-stage. The sum of the weight parts of HPC-8000-T65, HP7200, BT93 and SC2050 is 100 parts.

Eight sheets of prepreg and two pieces of electrolytic copper foil of one ounce are superimposed together, and laminated by hot-pressing equipment to obtain double-sided copper clad laminate. Laminating conditions are as follows: 1, when the material temperature is 80-120° C., the heating rate is controlled in 1.0-3.0° C./minute; 2, the pressure is set as 20 kg/cm²; 3, the curing temperature is 190° C., and the temperature is kept for 90 minutes. See table 2 for the corresponding properties.

The Chinese name or sources of the reagents involved in the table below are as follows:

DER530 is bisphenol A type brominated difunctional epoxy resin of DOW;
N695 is O-Methyl phenolic epoxy resin of DIC;
HP7200 is dicyclopentadiene epoxy resin of DIC;
NC7700L is naphthol type novolac epoxy resin;
AG-80 is epoxy produced by Shanghai Synthetic Material Institute;
EPPON501H is the trifunctional epoxy resin produced by Nippon Kayaku Co., Ltd;
TD2090 is the phenolic resin produced by DIC;
DICY is the dicyandiamide produced by Darong Industry Group Co., Ltd;
HF-10: bisphenol A type difunctional cyanate ester produced by Hui Feng Trade Co. Ltd.;
HPC-8000-T65 is the active ester without styrene structure produced by DIC;
SC2050 is the silica produced by Admatechs Company;
BT93 is the N, N-ethylene-bis(tetrabromophthalimide) produced by Albemarle;
HP3010 is the brominated polystyrene produced by Albemarle;
SPB100 is the phosphazene flame retardant produced by Otsuka Chemical Corporation;
SAYTEX8010 is the decabromodiphenyl ethane produced by Albemarle; Kaolin is produced by BASF;
PTFE powder is produced by Shanghai 3F New Materials Limited.

The testing standards or methods of the parameters involved in tables 1 and 2 are as follows:

Glass transition temperature (Tg): DSC test is adopted. Test is made according to DSC test methods specified in IPC-TM-650 2.4.25.
Peeling strength is tested according to the experimental conditions of “Post thermal stress” in IPC-TM-650 2.4.8 method.
Dielectric constant and dielectric loss angle tangent: it is tested under the 5 GHz accordance to SPDR method.
Evaluation of soldering resistance: copper clad laminate is impregnated in the tin stove of 288° C. for 20 seconds, and cooled down to room temperature. Then it is impregnated in the tin stove again, which is repeated 20 times. Soldering resistance is evaluated through observing the appearance.
PCT water absorption testing: The copper clad laminate is impregnated in the copper etching solution. The superficial copper foil is removed for substrate evaluation. The substrate is placed in a pressure cooker under 121° C., 2 atm for 2 hours for treatment. Then the water absorption rate of the substrate is tested. Evaluation of Solder resistanca after PCT: Copper clad laminate is impregnated in the copper etching solution. The superficial copper foil is removed for substrate evaluation. The substrate is placed in a pressure cooker under 121° C., 2 atm for 2 hours for treatment. Then it is impregnated in tin stove of 288° C. When the substrate bubbles or splits, the corresponding time is recorded. When the substrate does not bubble or delaminate after 5 minutes in the tin stove, evaluation can be ended. Combustion property is tested according to UL-94 test method.

TABLE 1

| | Examples | | | | | |
|---|---|---|---|---|---|---|
| | 1 | 2 | 3 | 4 | 5 | 6 |
| N695 | | | | 35 | | 25 |
| HP7200 | 30 | | | | | |
| NC7700L | | | | | 25 | |
| AG-80 | | | 30 | | | |
| EPPON501H | | 25 | | | | |
| active ester 1 | | | | 25 | | |
| containing styrene structure | | | | | | |
| active ester 2 | 35 | 50 | 60 | | | |
| containing styrene structure | | | | | | |
| active ester 3 | | | | | 40 | |
| containing styrene structure | | | | | | |
| active ester 3 | | | | | | |
| containing styrene structure | | | | | | |
| active ester 4 | | | | | | 15 |
| containing styrene structure | | | | | | |
| HF-10 | | | | | | 25 |
| SAYTEX8010 | | 20 | | | | |
| BT93 | 15 | | | 20 | 15 | |
| HP3010 | | | | | | 15 |
| SC2050 | 20 | | | 20 | 20 | 20 |
| Kaolin | | 5 | | | | |
| PTFE powder | | | 10 | | | |
| N,N-dimethylaminopyridine | | 0.075 | | | | |
| butyltriphentylphosphonium | | | 0.1 | | | |
| chloride | | | | | | |
| zinc naphthenate | | | | | | 0.02 |
| 2-MI | 0.1 | | | 0.1 | 0.1 | 0.1 |
| toluene | | 80 | | | | |
| DMF | | | 80 | | | |
| MEK | 70 | | | 70 | 70 | 70 |
| Tg (degree) | 175 | 192 | 183 | 182 | 185 | 208 |
| dielectric constant | 3.85 | 3.7 | 3.6 | 3.9 | 3.8 | 3.7 |
| dielectric loss angle tangent | 0.008 | 0.007 | 0.007 | 0.01 | 0.007 | 0.006 |
| soldering resistance | good | good | good | good | good | Good |
| peeling strength | 1.3 | 1.4 | 1.2 | 1.4 | 1.4 | 1.3 |
| PCT water absorption rate (%) | 0.25 | 0.28 | 0.27 | 0.28 | 0.27 | 0.26 |
| Solder resistance teat after | >300 | >300 | >300 | >300 | >300 | >300 |
| PCT (S) | | | | | | |
| Flame retardant | V0 | V0 | V0 | V0 | V0 | V0 |

Note:
content of each component is counted with weight part.

TABLE 2

| | Comparative example | | | | |
|---|---|---|---|---|---|
| | 1 | 2 | 3 | 4 | 5 |
| DER530 | 96.5 | 25 | 35 | | |
| 7200 | | | | | 30 |
| N695 | | | 10 | 35 | |
| active ester 5 | | 75 | | | |
| containing styrene | | | | | |
| structure | | | | | |
| active ester 6 | | | 10 | | |
| containing styrene | | | | | |
| structure | | | | | |
| HPC-8000-T65 | | | | | 35 |
| TD2090 | | | | 25 | |
| DICY | 3.5 | | | | |
| BT93 | | | | 20 | 15 |
| SPB100 | | | 20 | | |
| SC2050 | | | 25 | 20 | 20 |
| 2-MI | 0.05 | 0.1 | 0.1 | 0.1 | 0.1 |
| MEK | 80 | 90 | 40 | 70 | 70 |
| Tg (degree) | 135 | 133 | 165 | 170 | 172 |
| dielectric constant | 4.6 | 3.6 | 4.15 | 4.5 | 4.15 |
| dielectric loss | 0.015 | 0.008 | 0.010 | 0.017 | 0.009 |
| angle tangent | | | | | |
| soldering | bubble | delaminate | bubble | good | good |
| resistance | | | | | |
| Peeling strength | 2.0 | 0.35 | 1.2 | 1.4 | 1.4 |
| PCT water | 0.40 | 0.35 | 0.31 | 0.29 | 0.29 |
| absorption | | | | | |
| rate (%) | | | | | |
| Solder resistance | 200 | 160 | 180 | >300 | >300 |
| teat after | | | | | |
| PCT (S) | | | | | |
| Flame retardant | V0 | V0 | V0 | V0 | V0 |

Note:
content of each component is counted with weight part.

As shown in table 1, the Examples 1-6 of the present invention have low dielectric constant and dielectric loss factor, and good heat resistance, soldering resistance, moisture resistance, and moisture-heat resistance. On the other hand, the comparative example 1 wherein the Dicy curing epoxy resin is adopted has large dielectric constant and dielectric loss angle tangent, low glass transition temperature, and poor moisture-heat resistance; comparative example 2 has low glass transition temperature and peeling strength, and delamination occur in the moisture-heat resistance and soldering resistance test; the comparative example 3 has low glass transition temperature, poor soldering resistance and poor moisture-heat resistance (delamination occur in 300s in solder resistance test after PCT); compared with Example 4, the comparative example 4 wherein the board prepared from phenol novolac curing epoxy resin is adopted has large dielectric constant. Compared with comparative example 5, Example 1 wherein the board prepared from active ester containing styrene structure is adopted has better dielectric constant and water absorption property.

The applicant states that the present invention employs the above embodiments to describe the detailed method of the present invention, but the present invention is not limited to the above detailed method, i.e. it does not mean that the present invention must rely on the above detailed method to be implemented. Persons skilled in the art should understand, any improvement of the present invention, the equivalent replacement to the raw materials of the present invention product, adding auxiliary ingredients, specific mode selection and the like all fall within the protection scope and disclosure scope of the present invention.

1. A thermosetting resin composition, which comprises:
epoxy resin with 2 or more than 2 epoxy groups in each resin molecule;
and active ester containing styrene structure.

2. The thermosetting resin composition according to claim 1, wherein the active ester containing styrene structure has the following structure: 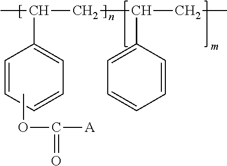
wherein A is substituted or unsubstituted phenyl, substituted or unsubstituted naphthyl, or C1-C8 alkyl, m and n are natural numbers, and m/n=0.8-19.

3. The thermosetting resin composition according to claim 1, wherein the epoxy resin is one or a mixture of at least two of the following epoxy resin: 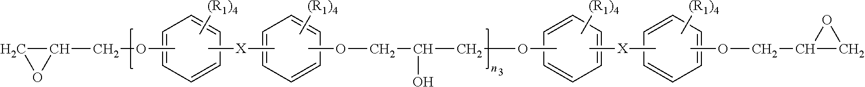
wherein R₁ is selected from hydrogen atom, halogen atom, substituted or unsubstituted C1-C8 straight chain alkyl, substituted or unsubstituted C1-C8 branched alkyl, substituted or unsubstituted alicyclic alkyl, substituted or unsubstituted C1-C10 alkoxy, substituted or unsubstituted phenyl; n₃ is any natural number; X is any one selected from the group consisting of —CH₂—, —O—, —CO—, —SO₂—, —S—, —CH(C₆H₅)—, —C(C₆H₅)₂—, —CH(CH₃)—, —C(CH₃)₂— or 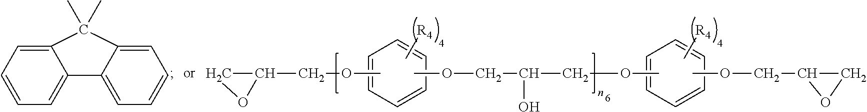
wherein R₄ is selected from hydrogen atom, halogen atom, substituted or unsubstituted C1-C8 straight chain alkyl, substituted or unsubstituted C1-C8 branched alkyl, substituted or unsubstituted alicyclic alkyl, substituted or unsubstituted C1-C10 alkoxy, substituted or unsubstituted phenyl; N₆ is any natural number;
or
phenol novolac type epoxy resin; methyl phenol novolac type epoxy resin; bisphenol A type epoxy novolac resin; bisphenol A type novolac epoxy resin; biphenyl epoxy resin; resorcinol type epoxy resin; naphthalene based epoxy resin; phosphorus containing epoxy resin; silicon containing epoxy resin; glycidyl amine type epoxy resin; cycloaliphatic epoxy resin; polyethylene glycol type epoxy resin; tetraphenol ethane tetraglycidyl ether; triphenolic methane type epoxy resin.

4. The thermosetting resin composition according to claim 1, wherein the epoxy resin is one or a mixture of at least two selected from the epoxy resins with the following the structure: 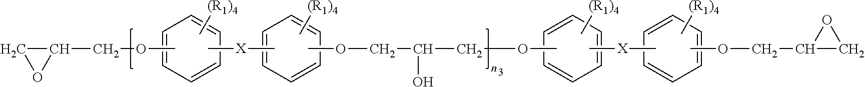
wherein R₁ is selected from the group consisting of hydrogen atom, halogen atom, substituted or unsubstituted C1-C8 straight chain alkyl, substituted or unsubstituted C1-C8 branched alkyl, substituted or unsubstituted alicyclic alkyl, substituted or unsubstituted C1-C10 alkoxy and substituted or unsubstituted phenyl; n₃ is any natural number; X is any one selected from the group consisting of —CH₂—, —O—, —CO—, —SO₂—, —S—, —CH(C₆H₅)—, —C(C₆H₅)₂—, —CH(CH₃)—, —C(CH₃)₂— or 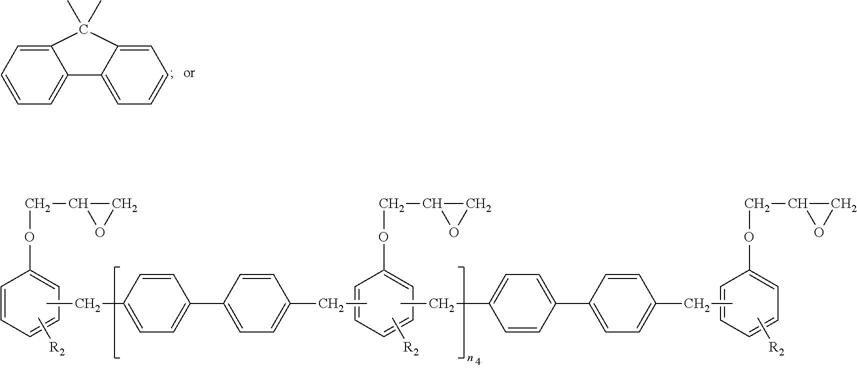
wherein R₂ is selected from the group consisting of hydrogen atom, halogen atom, substituted or unsubstituted C1-C8 straight chain alkyl, substituted or unsubstituted C1-C8 branched alkyl, substituted or unsubstituted alicyclic alkyl, substituted or unsubstituted C1-C10 alkoxy and substituted or unsubstituted phenyl; 0 [symbol] n₄ [symbol] 20, and n₄ is an integer;
or 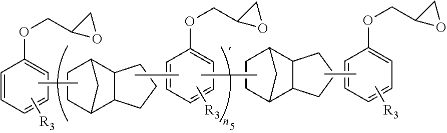
wherein R₃ is selected from the group consisting of halogen or hydrogen atom, substituted or unsubstituted C1-C8 straight chain alkyl, substituted or unsubstituted C1-C8 branched alkyl, substituted or unsubstituted alicyclic alkyl, substituted or unsubstituted C1-C10 alkoxy, substituted or unsubstituted phenyl; 0 [symbol] n₅ [symbol] 20, and n₅ is an integer;
or 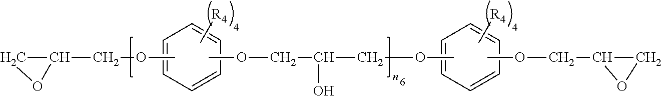
wherein R₄ is selected from the group consisting of hydrogen atom, halogen atom, substituted or unsubstituted C1-C8 straight chain alkyl, substituted or unsubstituted C1-C8 branched alkyl, substituted or unsubstituted alicyclic alkyl, substituted or unsubstituted C1-C10 alkoxy, substituted or unsubstituted phenyl; n₆ is any natural number;
or 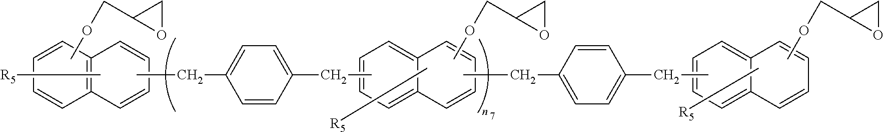
wherein R₅ is selected from the group consisting of hydrogen atom, halogen atom, substituted or unsubstituted C1-C8 straight chain alkyl, substituted or unsubstituted C1-C8 branched alkyl, substituted or unsubstituted alicyclic alkyl, substituted or unsubstituted C1-C10 alkoxy, substituted or unsubstituted phenyl; 0 [symbol] n₇ [symbol] 20, and n₇ is an integer.

5. The thermosetting resin composition according to claim 1, wherein the active ester containing styrene structure accounts for 11-70 wt % of the total weight of the thermosetting resin composition.

6. The thermosetting resin composition according to claim 1, wherein the thermosetting resin composition also comprises flame retardant; wherein the flame retardant agent is selected from halogen-based flame retardant and phosphorus-based flame retardant.

7. The thermosetting resin composition according to claim 6, wherein the halogen-based flame retardant is one or a mixture of at least two selected from the group consisting of bromophenol, brominated bisphenol A, decabromodiphenyl ether, brominated polystyrene, brominated polycarbonate, decabromodiphenyl ethane and N,N-ethylene-bis(tetrabromophthalimide); and the phosphorus-based flame retardant is one or a mixture of at least two selected from the group consisting of tri(2,6-dimethylphenyl)phosphine, tetrakis(2,6-dimethylphenyl) 1,3-phenylene bisphosphate, tetraphenyl resorcinol diphosphate, triphenyl phosphate, bisphenol-A bis(diphenyl phosphate), phosphazene flame retardant, 10-(2,5-dihydroxyphenyl)-10-hydro-9-xa-10-phosphaphenanthrene-10-oxide, 10-(2,5-dihydroxynaphthyl)-10-hydro-9-xa-10-phosphaphenanthrene-10-oxide or 9,10-dihydro-9-xa-10-phosphaphenanthrene-10-oxide flame retardant.

8. The thermosetting resin composition according to claim 6, wherein the flame retardant accounts for 5-30 wt % of the mass of thermosetting resin composition.

9. The thermosetting resin composition according to claim 1, which also comprises filler;
wherein the filler is any one or a mixture of at least two selected from the group consisting of aluminum hydroxide, magnesium hydroxide, kaolin, talcum powder, hydrotalcite, calcium silicate, beryllium oxide, boron nitride, glass powder, silicon powder, zinc borate, aluminum nitride, silicon nitride, silicon carbide, magnesium oxide, zirconium oxide, mullite, titanium dioxide, potassium titanate, hollow glass bead, potassium titanate fiber, silicon carbide monocrystalline fiber, silicon nitride fiber, aluminum oxide monocrystalline fiber, short glass fiber, polytetrafluoroethylene powder, polyphenylene sulfide powder and polystyrene powder.

10. The thermosetting resin composition according to claim 9, the filler accounts for 5-60 wt % of the mass of the thermosetting resin composition.

11. The thermosetting resin composition according to claim 1, which also comprises catalyst;
wherein the catalyst is any one or a mixture of at least two selected from the group consisting of tertiary amine, tertiary phosphine, quaternary ammonium salt, quaternary phosphonium salt and imidazole compound.

12. The thermosetting resin composition according to claim 11, wherein the tertiary amine is any one or a mixture of at least two selected from the group consisting of triethylamine, tributylamine, dimethylethanolamine, N,N-dimethylamino pyridine and phenmethyl dimethylamine; the tertiary phosphine is selected from triphenylphosphine and trialkyl phosphine; the quaternary ammonium salt is any one or a mixture of at least two selected from the group consisting of tetramethylammonium bromide, tetramethylammonium chloride, tetramethylammonium iodide, benzyltrimethylammonium chloride, benzyltriethylammonium chloride and hexadecyl trimethyl ammonium bromide; the quaternary phosphonium salt is any one or a mixture of at least two selected from the group consisting of tetrabutylphosphonium chloride, tetrabutylphosphonium bromide, tetrabutylphosphonium iodide, tetraphenylphosphonium chloride, tetraphenylphosphonium bromide, tetraphenylphosphonium iodide, ethyl-triphenylphosphonium chloride, propyltriphenylphosphonium chloride, propyltriphenylphosphonium bromide, propyltriphenylphosphonium iodide, butyltriphenylphosphonium chloride, butyltriphenylphosphonium bromide, butyltriphenylphosphonium iodide; and the imidazole compound is one or a mixture of at least two selected from the group consisting of 2-methylimidazole, 2-ethyl-4-methylimidazole, 2-phenylimidazole, 2-undecylimidazole, 1-benzyl-2-methylimidazole, 2-heptadecylimidazole, 2-isopropylimidazole, 2-phenyl-4-methylimidazole, 2-dodecylimidazole and cyanoethyl-2-methylimidazole.

13. The thermosetting resin composition according to claim 11, wherein, the catalyst accounts for 0.001-5.0 wt % of the mass of the thermosetting resin composition.

14. The thermosetting resin composition according to claim 1, wherein, the thermosetting resin composition also comprises solvent, which is one or a mixture of at least two selected from the group consisting of ketones, hydrocarbons, ethers, esters and aprotic solvent.

15. The thermosetting resin composition according to claim 1, wherein, the thermosetting resin composition also comprises any one or a mixture of at least two selected from the group consisting of polyphenylene ether, cyanate resin or BT resin.

16. The thermosetting resin composition according to claim 15, wherein, the cyanate resin is prepared from any one or a mixture of at least two of the following monomer, any one or a mixture of at least two of the prepolymers of the following monomers, or a mixture of any one or at least two of the following monomers with any one or at least two of the prepolymers of the following monomers: bisphenol-A type cyanate, 2,2-bis(cyanatophenyl)propane, bis(cyanatophenyl)ethane, bis(cyanatophenyl)methane, bis(4-cyanato-3,5-dimethylphenyl)methane, 2,2-bis(4-cyanatophenyl)hexfluoropropane, bis(4-cyanatophenyl)sulfoether, novolac cyanate resin and cyanate ester containing dicyclopentadiene structure.

17. The thermosetting resin composition according to claim 1, wherein, the thermosetting resin composition also comprises any one or a mixture of at least two selected from the group consisting of dyes, pigments, surfactant, leveling agent or ultraviolet absorbent.

18. A resin sheet, a resin composite metallic foil or a prepreg prepared with the thermosetting resin composition according to claim 1.

19. A laminate or a metal clad laminate prepared with the resin sheet, the resin composite metallic foil or the prepreg according to claim 18.

20. A printed circuit board prepared with the resin sheet, the resin composite metal foil or the prepreg according to claim 18.
